(19) United States
(12) Patent Application Publication
(10) Pub. No.: US 2012/0067531 A1
(43) Pub. Date: Mar. 22, 2012

(54) Reconfigurable Shade

(76) Inventor: Anna Ehrsam, Brooklyn, NY (US)

(21) Appl. No.: 13/233,911

(22) Filed: Sep. 15, 2011

Related U.S. Application Data
(60) Provisional application No. 61/383,650, filed on Sep. 16, 2010.

(51) Int. Cl. A47H 99/00; H01F 7/02

(52) U.S. Cl. 160/368.1; 160/405

(57) ABSTRACT

A removable screen system comprising a plurality of magnetic fasteners, a formable material comprising one or a plurality of receptacles for receiving the magnetic fasteners, an attachment surface external to the formable material and magnetically compatible with the magnetic fasteners, wherein the formable material is movable along the attachment surface.

### BACKGROUND

This invention relates to a reconfigurable shade, and more particularly to a removable screen or panel that is magnetically moveable along a window or other surface using the inherent metal embedded in the environment, such as corner bead or steel beams around windows or doors.

### SUMMARY

The present invention is directed to a magnetic removable screen system.

In an implementation, the invention relates to a removable screen apparatus with a plurality of magnetic fasteners and a formable material, where the formable material has at least two opposing sides that are configured to receive one or more of the magnetic fasteners in each of the opposing sides.

In one implementation, the magnetic fasteners are magnetic strips that can be continuous along one or more sides of the formable material. The magnetic strips can also be continuous along the entire perimeter of the formable material.

In another implementation, the magnetic fasteners are individual magnets or magnetic disks that can have various shapes, for example, they can be spherically shaped. The magnetic fasteners can be distributed along the perimeter of the formable material, throughout the surface, or in the corners of the formable material. The magnetic fasteners can be distributed evenly, in a pattern, or randomly. The magnetic fasteners can also be distributed in a tessellation pattern.

In various implementations of the invention, the formable material can be penetrable by light, partially penetrable by light or impenetrable to light. The formable material can be a solar screen. The formable material can also be permeable to air or impermeable to air. Further yet, the formable material can be permeable to water or impermeable to water. The formable material can also be fire resistant. The formable material can also be flexible, semi-flexible, semi-rigid or rigid. The formable material can also be reusable origami paper and can be formed into three-dimensional shapes. In yet further implementations, the formable material can be a textile, plastic or an insect screen. The formable material can also be nonflammable. The formable material can also include fiber optic lights or a photovoltaic solar cell circuit for an illuminated solar shade.

In another implementation, the invention relates to a removable screen system with a plurality of magnetic fasteners, a formable material having one or a plurality of receptacles for receiving the magnetic fasteners, and an attachment surface external to the formable material that is magnetically compatible with the magnetic fasteners and where the formable material is movable along the attachment surface.

In implementations, the receptacles can be pockets, folds, adhesives or other types of means for securing the plurality of magnetic fasteners. In some implementations, the attachment surface can be integral to a window, a wall, a ceiling, or another type of surface. The attachment surface can also be affixed to a window, wall, ceiling or other type of surface, for example by means of screws, snaps, tacks or adhesive. The attachment surface can also be removable. The attachment surface can include a magnetic material or a ferromagnetic material.

In further implementations, the attachment surface can be a track or a strip of material, or any other shaped surface. The attachment surface can also be a ball bearing or roller bearing. The attachment surface can also be an electric magnetic track or a curtain rod with magnetic or ferromagnetic properties.

In implementations, the formable material slides along the attachment surface. In other implementations, the formable material rolls along the attachment surface.

In implementations, the formable material can be rectangular, circular, a polygon, or any other geometric or non-geometric shape. In further implementations, multiple pieces of the formable material can connect to form layers or larger panels.

The invention can be used as a window shade, for example, to partially or completely block light, air, or insects. The invention can also be used as a room divider or a projection screen.

One or more implementations of this invention have the following advantages: implementations of the invention do not use hanging cords or rods that can cause injury, especially to small children; the installation is fast, easy and simple without the need for additional tools or mechanisms; implementations of the invention are transformative and interactive; implementations of the invention minimize damage to walls by eliminating the need for drilling holes; implementations of the invention are easily removable; implementations of the invention are simple and inexpensive; implementations of the invention can provide a variety of functions including privacy, light control, airflow control, temperature control, decoration, interactive sculpture and innovative design; implementations of the invention can be used as a window shade, a room divider, a projection screen, an artistic display, or as part of an installation; implementations of the invention can include solar panels and can be used to reduce the carbon footprint of a building; implementations of the invention can also be used to illuminate a building.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front view of an implementation of a removable screen apparatus of this invention.

FIG. 2 is a front view of an implementation of a removable screen apparatus of this invention.

FIG. 3A is a three dimensional view of an implementation of a removable screen system of this invention.

FIG. 3B is a side view of an implementation of a removable screen system of this invention.

FIG. 3C is a side view of an implementation of a removable screen system of this invention.

FIG. 3D is a side view of an implementation of a removable screen system of this invention.

FIG. 3E is a side view of an implementation of a removable screen system of this invention.

FIG. 4A is a front view of a removable screen system embodying aspects of this invention.

FIG. 4B is a front view of a removable screen system embodying aspects of this invention.

FIG. 5 is a front view of a removable screen system embodying aspects of this invention.

FIG. 6 is a front view of a removable screen system embodying aspects of this invention.

FIG. 7 is a front view of a removable screen system embodying aspects of this invention.

FIG. 8 is a front view of a removable screen system embodying aspects of this invention.

FIG. 9 is a three dimensional view of a removable screen system embodying aspects of this invention.

Like reference symbols in the various drawings indicate like elements.

### DETAILED DESCRIPTION

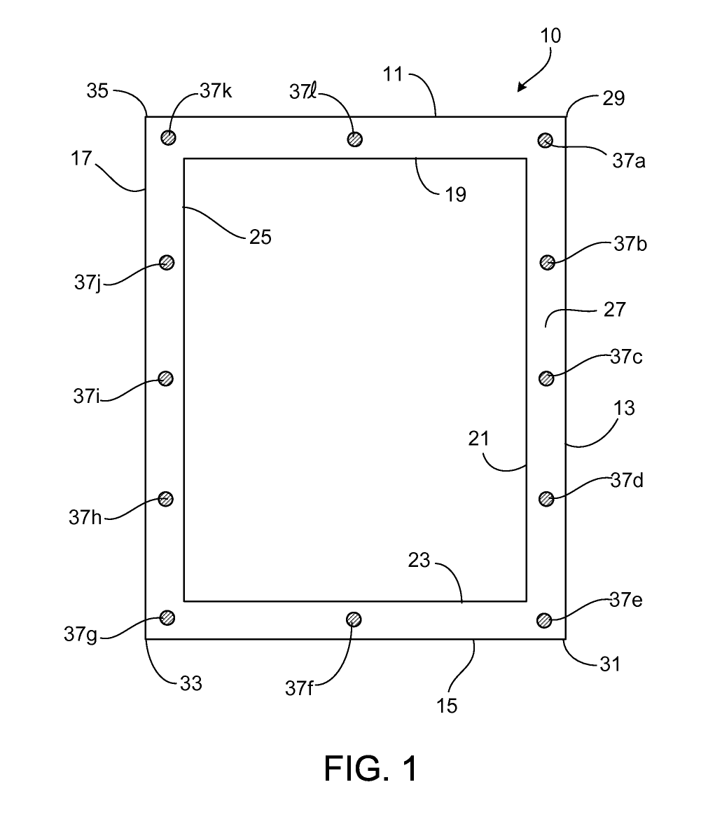

Referring initially to FIG. 1, removable screen 10 includes a top edge 11, a right edge 13, a bottom edge 15 and a left edge 17. Removable screen 10 also includes corners 29, 31, 33 and 35. As illustrated in FIG. 1, removable screen 10 has a rectangular shape, but can have any other geometric shape, for example, a circle, a polygon, or other non-geometric shape.

Removable screen 10 can include magnets 37a, 37b, 37c, 37d, 37e, 37f, 37g, 37h, 37i, 37j, 37k and 37l. Alternatively, removable screen 10 can include continuous magnetic strips along edges 11, 13, 15 and 17. As illustrated in FIG. 1, removable screen 10 includes 12 magnets 37a-l, but can include any number of magnets. As further illustrated in FIG. 1, magnets 37a-l are distributed evenly along edges 11, 13, 15 and 17, but they can be distributed in any way, for example, evenly, in a particular pattern, or randomly.

Magnets 37a-l can be coupled to removable screen 10 by means of receptacle 27, having a top outer edge 11, a top inner edge 19, a right outer edge 13, a right inner edge 21, a bottom outer edge 15, a bottom inner edge 23, a left outer edge 17 and a left inner edge 25. As illustrated in FIG. 1, receptacle 27 can be a pocket or a fold that runs along edges 11, 13, 15 and 17 of removable screen 10. Receptacle 27 can be made of the same material as removable screen 10 or can be made of another material. Receptacle 27 can be affixed to removable screen 10 or can be removable. Receptacle 27 can be a continuous pocket along the perimeter of removable screen 10, as illustrated in FIG. 1.

Removable screen 10 can also include a plurality of receptacles. Each of the magnets 37a-l can be coupled to removable screen 10 by means of an individual receptacle or groups of magnets can be coupled by means of the same receptacle. Receptacles can include pockets, fasteners, or any other mechanisms or means that can receive a magnet. Magnets 37a-l are secured in place and are not movable in the field of the formable material.

Magnets 37a-l can be coupled to removable screen 10 such that they are not visible when viewed from a given perspective of the formable material. Receptacle 27 and any other receptacles can also be kept out of view.

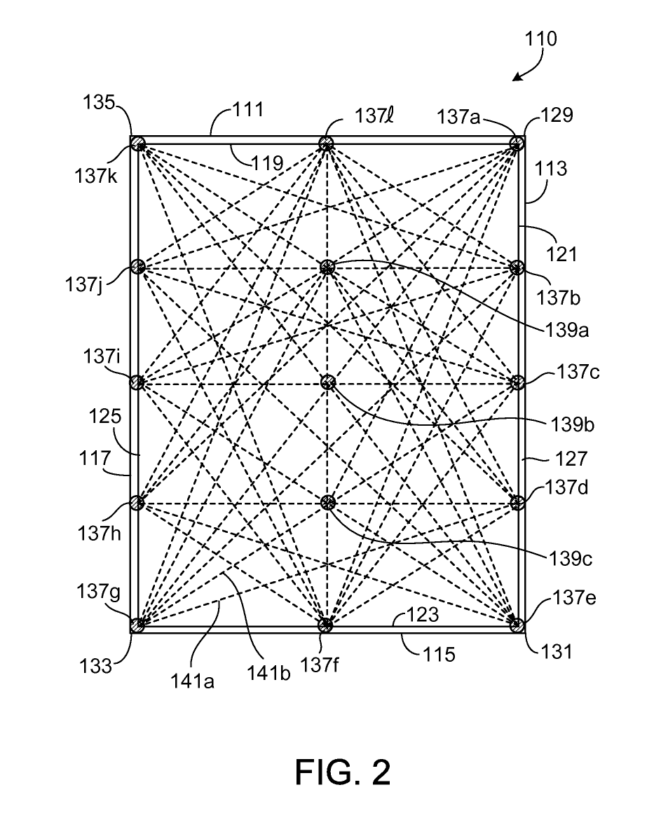

Referring to FIG. 2, removable screen 110 is shown having a top edge 111, a right edge 113, a bottom edge 115 and a left edge 117. As illustrated in FIG. 2, removable screen 110 has a rectangular shape, but can have any other shape, for example, a circle, a polygon, or other non-geometric shape.

Removable screen 110 includes magnets 137a, 137b, 137c, 137d, 137e, 137f, 137g, 137h, 137i, 137j, 137k and 137l along edges 111, 113, 115 and 117 or individual points 137a, 137b, 137c, 137d, 137e, 137f, 137g, 137h, 137i, 137j, 137k and 137l on a continuous magnetic strip along edges 111, 113, 115 and 117. In addition to magnets 137a, 137b, 137c, 137d, 137e, 137f, 137g, 137h, 137i, 137j, 137k and 137l, removable screen 110 can also include magnets throughout its surface, such as magnets 139a, 139b and 139c.

As illustrated in FIG. 2, removable screen 110 includes 15 magnets 137a-l and 139a-c, but can include any number of magnets. As further illustrated in FIG. 2, magnets 137a-l and 139a-c are distributed evenly along edges 111, 113, 115 and 117 and throughout the surface of removable screen 110, but they can be distributed in any way, for example, evenly, in a particular pattern, or randomly.

Magnets 137a-l and 139a-c can be coupled to removable screen 110 by means of a receptacle or a plurality of receptacles. For example, as illustrated in FIG. 2, magnets 137a-l can be coupled to removable screen 110 by means of receptacle 127 having a top outer edge 111, a top inner edge 119, a right outer edge 113, a right inner edge 121, a bottom outer edge 115, a bottom inner edge 123, a left outer edge 117 and a left inner edge 125. As illustrated in FIG. 2, receptacle 127 can be a pocket or a fold that runs along edges 111, 113, 115 and 117 of removable screen 110. Receptacle 127 can be made of the same material as removable screen 110 or can be made of another material. Receptacle 127 can be affixed to removable screen 110 or can be removable. Receptacle 127 can be a continuous pocket along the perimeter of removable screen 110, as illustrated in FIG. 2.

Magnets 139a-c can be coupled to removable screen 110 by means of another receptacle (not shown in FIG. 2), for example, a pocket or strip of material or other fastener means.

Removable screen 110 can also include a plurality of receptacles. Each of the magnets 137a-l and 139a-c can be coupled to removable screen 110 by means of an individual receptacle or groups of magnets can be coupled by means of the same receptacle. Receptacles can include pockets, fasteners, or any other mechanisms or means that can receive a magnet.

Magnets 137a-l and 139a-c can be coupled to removable screen 110 such that they are not visible from a given perspective of the formable material. Receptacle 127 and any other receptacles can also be kept out of view.

FIG. 2 shows a fold line between each pair of magnets 137a-l and 139a-c, for example, fold line 141a between magnets 137g and 137d, and fold line 141b between magnets 137g and 139c. These fold lines will be discussed in more detail below.

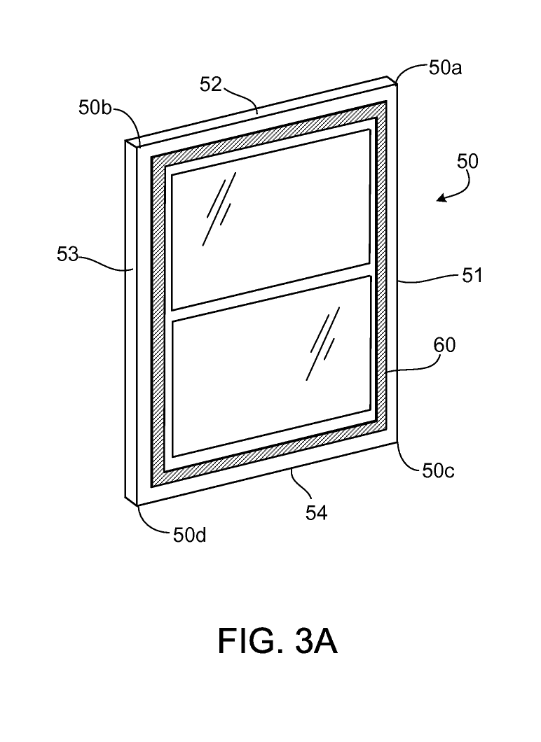

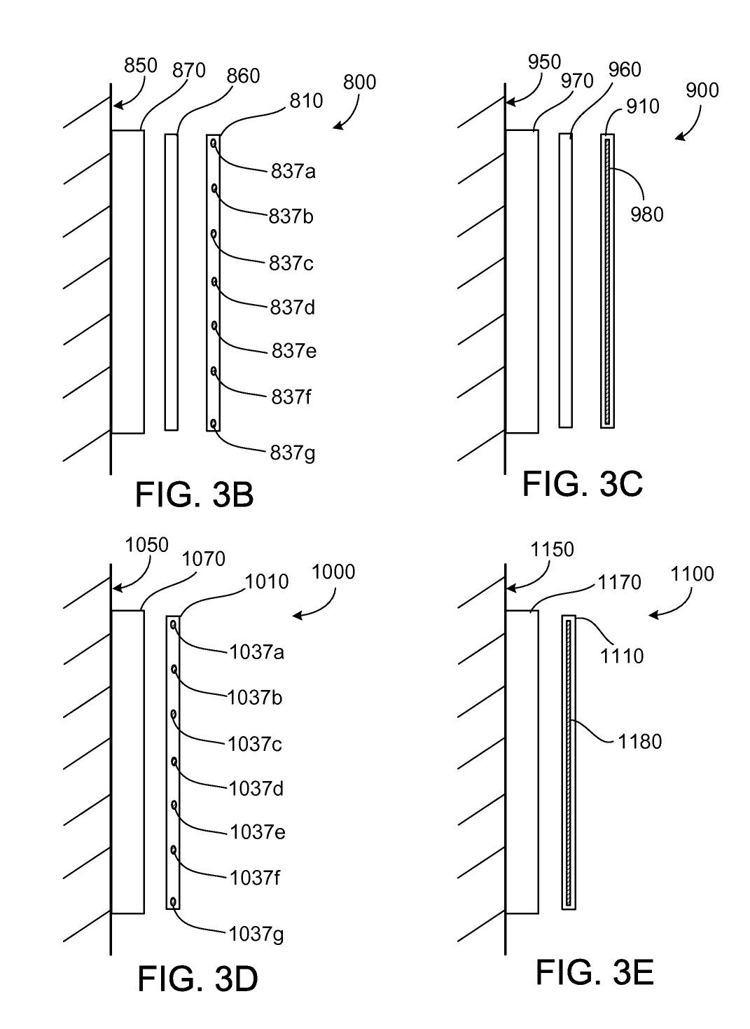

A removable screen, such as removable screen 10 or removable screen 110, can be magnetically coupled to a window or other frame by the magnetic attraction of the magnets within the removable screen to magnetically compatible elements such as corner bead. In the absence of corner bead or other property within a window or frame that would result in magnetic attraction of the magnets within the removable screen to the wall or screen, the removable screen can be magnetically coupled to a window or other frame by means of an attachment surface. Referring now to FIG. 3A, attachment surface 60 is coupled to a window 50. Attachment surface 60 is a continuous strip of material along window edges 51, 52, 53 and 54. Attachment surface 60 is made of magnetic, ferromagnetic or other material that would result in magnetic attraction to the magnets within a removable screen. Attachment surface 60 can be permanently affixed to window 50, for example by means of screws or permanent adhesive or can be attached by removable means, such as Velcro, pins, tacks or a removable adhesive. As illustrated in FIG. 3A, attachment surface is a continuous strip of material but can also include multiple strips of material or individual small pieces of material distributed where needed, for example, at corners 50a, 50b, 50c and 50d of window 50.

Referring now to FIG. 3B, a side view of a removable screen system 800 is shown. Attachment surface 860 is coupled to frame 870 of window 850. Removable screen 810 includes magnets 837a-g, which are magnetically coupled to attachment surface 860.

Referring now to FIG. 3C, a side view of a removable screen system 900 is shown. Attachment surface 960 is coupled to frame 970 of window 950. Removable screen 910 includes a continuous magnetic strip 980, which is magnetically coupled to attachment surface 960.

Referring now to FIG. 3D, a side view of a removable screen system 1000 is shown. Frame 1070 of window 1050 includes corner bead (not shown in FIG. 3D), or other material embedded within window 1050 capable of magnetic attraction, therefore an attachment surface is not needed. Removable screen 1010 includes magnets 1037a-1037g, which are magnetically coupled to frame 1070.

Referring now to FIG. 3E, a side view of a removable screen system 1100 is shown. Frame 1170 of window 1150 includes corner bead (not shown in FIG. 3E), or other material embedded within window 1150 or frame 1170 capable of magnetic attraction, therefore an attachment surface is not needed. Removable screen 1110 includes a continuous magnetic strip 1180, which is magnetically coupled to frame 1170.

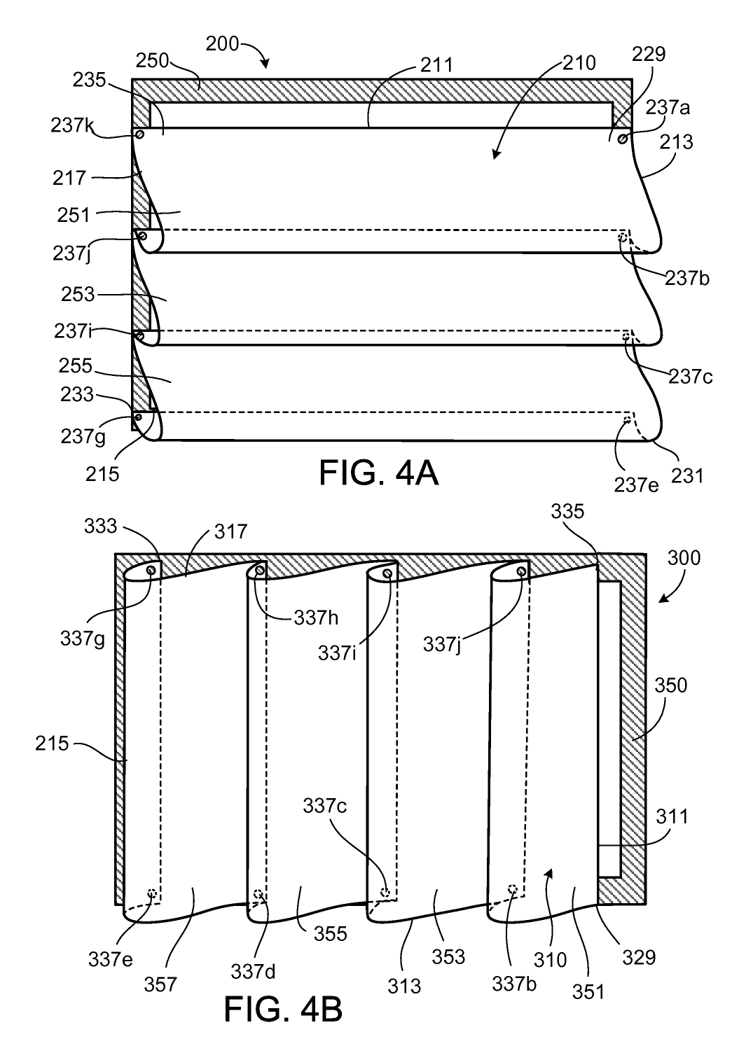

Referring now to FIG. 4A, the removable screen arrangement 200 is an example of a horizontal Roman shade arrangement of the removable screen 10 of FIG. 1 or removable screen 110 of FIG. 2. Removable screen 210, as illustrated in FIG. 4, has a rectangular shape and has a top edge 211, a right edge 213, a bottom edge 215 (not shown in FIG. 4) and a left edge 217, is coupled to window 250. Removable screen 210 includes a plurality of magnets (not shown in FIG. 4), as discussed in FIG. 1. For aesthetic purposes, some or all of the magnets can be kept out of view. In particular, there is at least a magnet 237a at corner 229, a magnet 237e at corner 231, a magnet 237g at corner 233, a magnet 237k at corner 235, magnets 237b and 237c along right edge 213, and magnets 237i and 237j along left edge 217.

Removable screen 210 is magnetically coupled to window 250. Removable screen 210 can be magnetically coupled to window 250 by virtue of corner bead that is embedded within the frame of window 250, which is commonly found in many households. Alternatively, removable screen 210 can be magnetically coupled to window 250 by means of an attachment surface 260 (not shown in FIG. 4), as discussed above.

Arrangement 200 is achieved by first magnetically coupling removable screen 210 to window 250 such that right edge 213 of removable screen 210 is parallel to the right edge of window 250, that left edge 217 of removable screen 210 is parallel to the left edge of window 250, and that removable screen 210 lays flat on top of window 250, as shown in FIG. 1 or FIG. 2. Magnets 237b and 237j slide up along the left and right edges of window 250 to create fold 251 in removable screen 210 as shown in FIG. 4. Similarly, magnets 237c and 237i slide up along the left and right edges of window 250 to create fold 253, and magnets 237e and 237g slide up along the edges of window 250 to create fold 255.

Referring now to FIG. 4B, the removable screen arrangement 300 is an example of a vertical Roman shade arrangement of the removable screen 10 of FIG. 1 or removable screen 110 of FIG. 2, and is achieved similarly to arrangement 200 of FIG. 4A, that is, by sliding pairs of magnets 337b with 337j, 337c with 337i, 337d with 337h, and 337e with 337g, along the edges of window 350, to create folds 351, 353, 355 and 357.

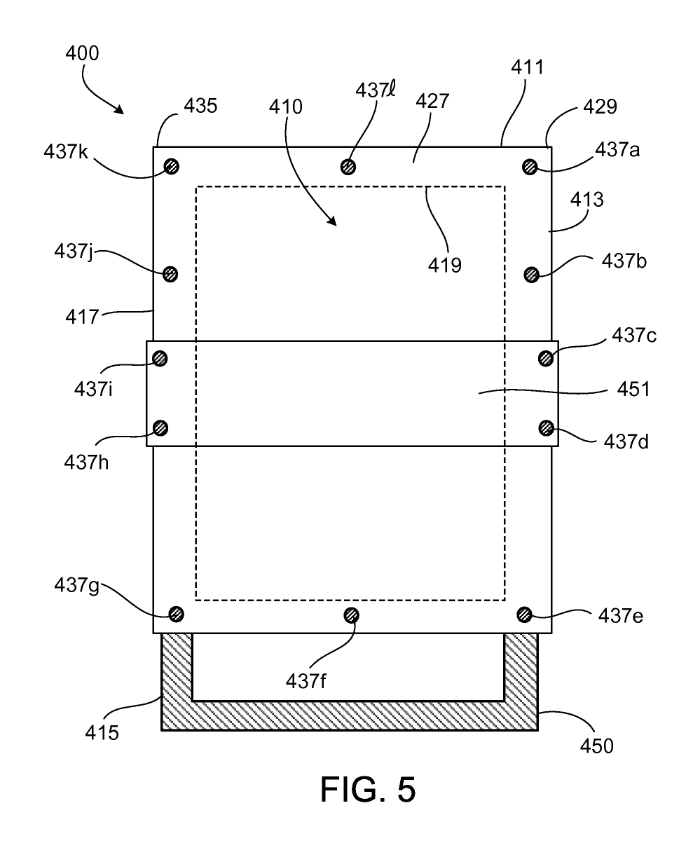

Referring now to FIG. 5, removable screen arrangement 400 is an example of another arrangement of removable screen 10 of FIG. 1 or removable screen 110 of FIG. 2. Arrangement 400 is achieved by first magnetically coupling removable screen 410 to window 450, but unlike arrangements 200 and 300 of FIGS. 4A and 4B, arrangement 400 is achieved by lifting pairs of magnets 437c with 437i, and 437d with 437h and placing them along the edges of window 450 to create fold 451.

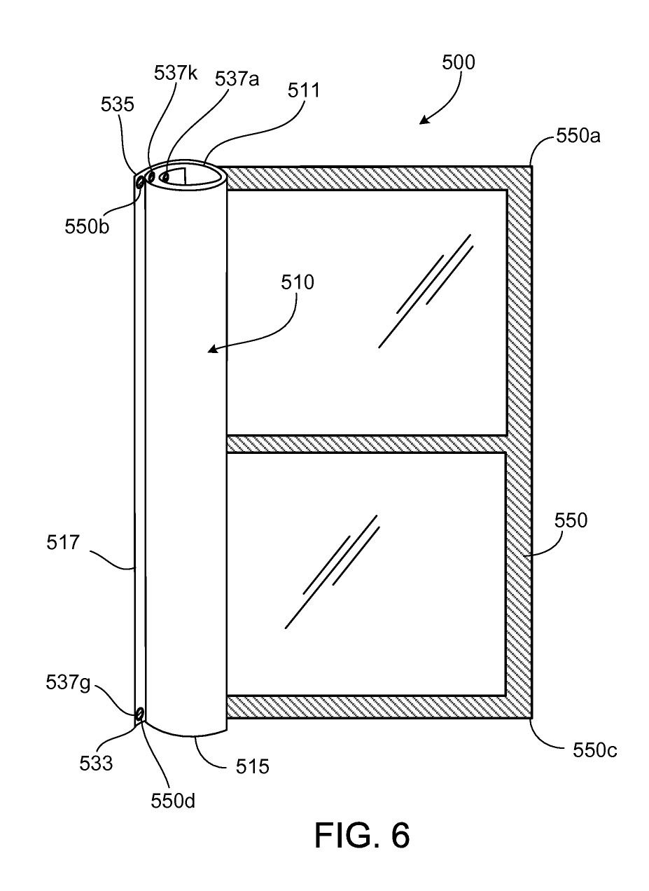

Referring now to FIG. 6, removable screen arrangement 500 is an example of a side roll arrangement of removable screen 10 of FIG. 1 or removable screen 110 of FIG. 2. Arrangement 500 is achieved by starting with removable screen 510 flat on top of and magnetically coupled to window 550. Instead of sliding magnets, magnets are lifted and joined with other magnets to create rolls or folds. For example, referring to FIG. 6, magnet 537a, which is coupled to the upper right corner 529 (not shown in FIG. 6) of removable screen 510 and to the upper right corner 550a of window 550, is lifted. Simultaneously, magnet 537e (not shown in FIG. 6), coupled to the lower right corner 531 (not shown in FIG. 6) of removable screen 510, is lifted. Removable screen 510 is then rolled in the left direction toward left edge 517 of removable screen 510. Magnet 537a is joined with magnet 537k at the upper left corner 535 of removable screen 510 and at the upper left corner 550b of window 550. Magnet 537e is joined with magnet 537g at the bottom left corner 533 of removable screen 510 and at the bottom left corner 550d of window 550.

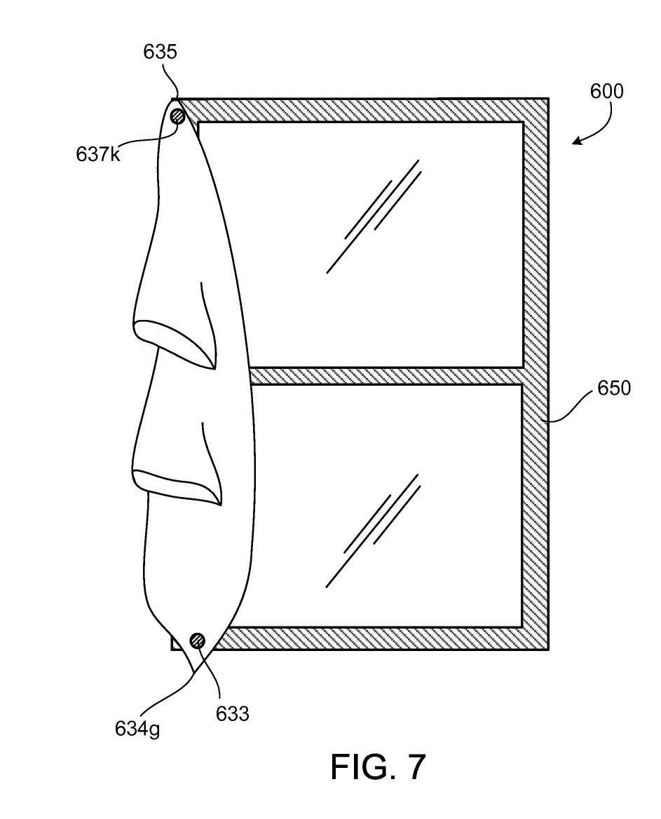

Referring now to FIG. 7, removable screen arrangement 600 is an example of a draped arrangement of removable screen 10 of FIG. 1 or removable screen 110 of FIG. 2. Similarly to arrangement 500 of FIG. 6, arrangement 600 is achieved by lifting particular magnets and displacing them to make contact with other magnets, thus creating folds and rolls, and forming a desired shape, such as the shape shown in FIG. 7.

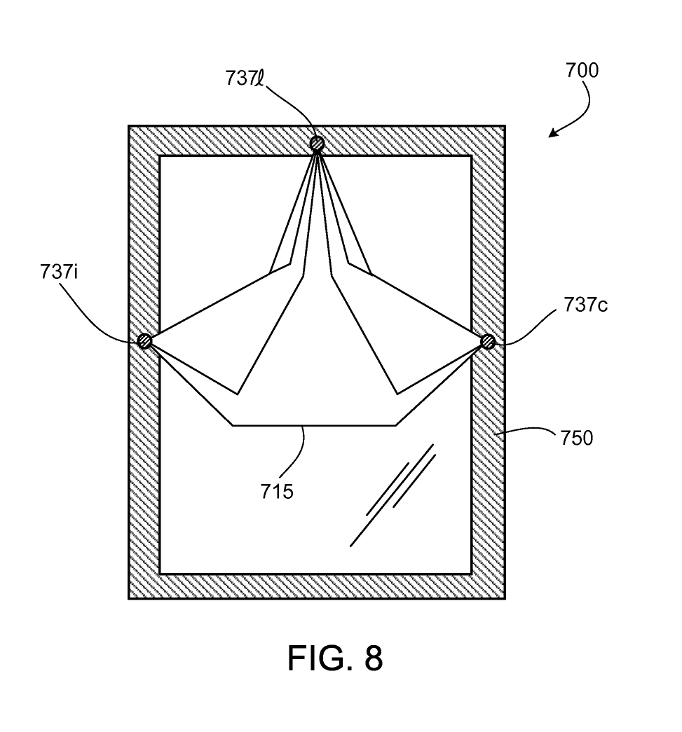

Referring now to FIG. 8, removable screen arrangement 700 is an example of a shaped arrangement of removable screen 110 of FIG. 2. Similarly to arrangement 600 of FIG. 7, arrangement 700 is achieved by lifting particular magnets and displacing them to make contact with other magnets, thus creating folds and rolls, and forming a desired shape, such as the shape shown in FIG. 8.

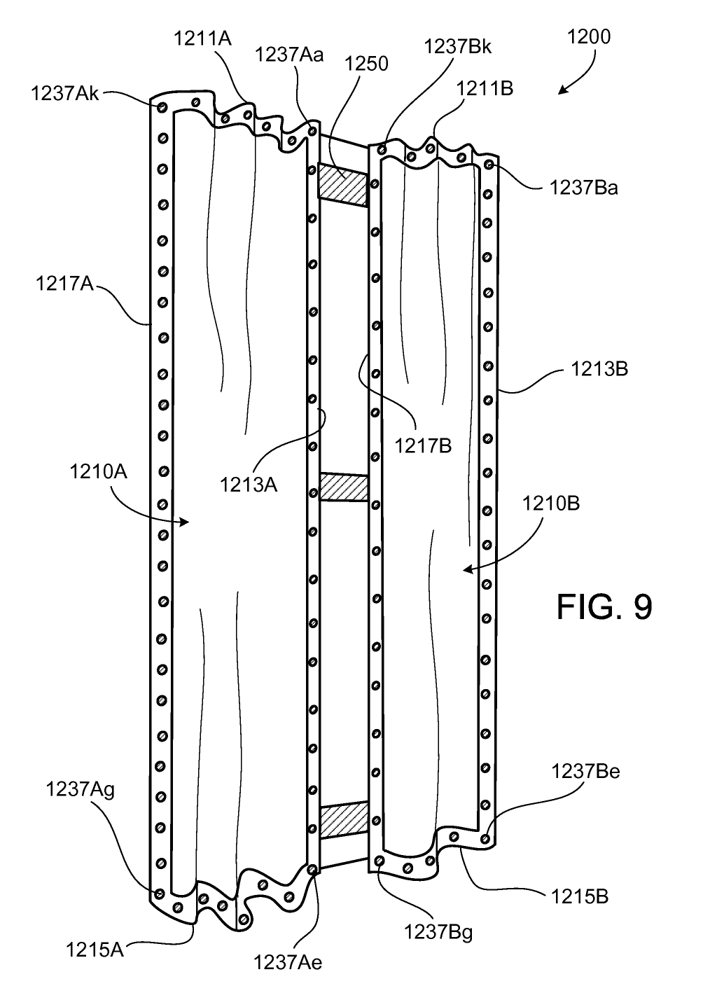

Referring now to FIG. 9, removable screen arrangement 1200 is an example of a classic curtain arrangement of removable screen 10 of FIG. 1. Arrangement 1200 includes two removable screens 1210A and 1210B. Removable screen 1210A includes a top edge 1211A, a right edge 1213A, a bottom edge 1215A and a left edge 1217A. Removable screen 1210B includes a top edge 1211B, a right edge 1213B, a bottom edge 1215B and a left edge 1217B. Removable screen 1210A includes a plurality of magnets, including but not limited to magnets 1237Aa, 1237Ae, 1237Ag and 1237Ak. Removable screen 1210B includes a plurality of magnets, including but not limited to magnets 1237Ba, 1237Be, 1237Bg and 1237Bk. Removable screens 1210A and 1210B are magnetically coupled to window 1250 along left edge 1217A and top edge 1211A of removable screen 1210A and right edge 1213B and top edge 1211B of removable screen 1210B. Removable screens 1210A and 1210B can also be magnetically coupled to window 1250 along bottom edges 1215A and 1215B. Removable screens 1210A and 1210B can be opened and closed by sliding magnets 1237Aa and 1237Bk left and right along window 1250, or by sliding the pair of magnets 1237Aa and 1237Ae and the pair of magnets 1237Bk and 1237Ba left and right along window 1250.

Various additional implementations of this invention are described and shown in the Appendix. Other embodiments are included within the scope of the claims.

What is claimed is:

1. A removable screen system comprising:
a plurality of magnetic fasteners;
a formable material comprising one or a plurality of receptacles for receiving the magnetic fasteners;
an attachment surface external to the formable material and magnetically compatible with the magnetic fasteners; and
wherein the formable material is movable along the attachment surface.

2. The removable screen apparatus of claim 1, wherein the magnetic fasteners are magnetic strips.

3. The removable screen apparatus of claim 1, wherein the magnetic fasteners are individual magnets.

4. The removable screen apparatus of claim 1, wherein the magnetic fasteners are distributed along the perimeter of the formable material.

5. The removable screen apparatus of claim 1, wherein the magnetic fasteners are distributed throughout the surface of the formable material.

6. The removable screen apparatus of claim 1, wherein the formable material is flexible.

7. The removable screen apparatus of claim 1, wherein the formable material is a textile.

8. The removable screen system of claim 1, wherein the receptacles are pockets.

9. The removable screen system of claim 1, wherein the receptacles are fasteners.

10. The removable screen system of claim 1, wherein the receptacles are adhesives.

11. The removable screen system of claim 1, wherein the attachment surface is integral to a window.

12. The removable screen system of claim 1, wherein the attachment surface is integral to a wall.

13. The removable screen system of claim 1, wherein the attachment surface is affixed to a window.

14. The removable screen system of claim 1, wherein the attachment surface is affixed to a wall.

15. The removable screen system of claim 1, wherein the attachment surface is removable.

16. The removable screen system of claim 1, wherein the attachment surface is a track.

17. The removable screen system of claim 1, wherein the attachment surface is a ball bearing.

18. The removable screen system of claim 1, wherein the formable material slides along the attachment surface.

19. The removable screen system of claim 1, wherein the formable material rolls along the attachment surface.

20. A method of providing a removable screen, the method comprising:
providing a plurality of magnetic fasteners;
providing a formable material;
coupling one or more of the magnetic fasteners to the formable material;
providing an attachment surface external to the formable material and magnetically compatible with the magnetic fasteners; and
moveably engaging the formable material and the attachment surface.
